(19) United States
(12) Patent Application Publication
(10) Pub. No.: US 2001/0024952 A1
(43) Pub. Date: Sep. 27, 2001

(54) Wireless network with an error handling procedure for a false key

(76) Inventors: Christoph Herrmann, Aachen (DE); Josef Wasel, Bedburg (DE)

Correspondence Address: Corporate Patent Counsel, U.S. Philips Corporation, 580 White Plains Road, Tarrytown, NY, 10591, US

(21) Appl. No.: 09/795,003

(22) Filed: Feb. 28, 2001

(30) Foreign Application Priority Data
Feb. 29, 2000 (DE) 10009447.3

(51) Int. Cl. H04M 1/66

(52) U.S. Cl. 455/419; 455/410; 455/560

(57) ABSTRACT

The invention relates to a wireless network comprising a radio network controller and a plurality of assigned terminals which are used for coding certain data to be transmitted in dependence on a key that can be changed at certain intervals. In the case of a wrongly used key, a terminal sends a predefined number of status messages after all the queues contained in the terminal have been emptied or when a predefined minimum filling level is fallen short of and releases all the resources used when no reconfiguration message has been received from the radio network controller after the status messages have been sent.

The invention relates to a wireless network comprising a radio network controller and a plurality of assigned terminals which are provided for coding specific data to be transmitted in dependence on a key that can be changed at certain intervals.

From the document “3^{rd} Generation Partnership Project; Technical Specification Group Radio Access Networks; Interlayer Procedures in Connected Mode (3G TS 25.303 version 3.2.0)” a wireless network is known in which the key for the coding of data or messages is changed at regular intervals. In the case where in the terminal, for example, as a result of an erroneous transmission, a false key is used, the terminal cannot itself recognize this. On the other hand, as a result of the false key this terminal can no longer be used by the assigned radio network controller, so that it cannot be selected by the radio network controller to release the resources used (error situation).

It is an object of the invention to provide a wireless network that avoids the error situation in the case of a key being erroneously transmitted to a terminal.

The object is achieved by a wireless network of the type defined in the opening paragraph in that a terminal is provided for sending a predefined number of status messages in the case of an erroneously used key after all the queues in the terminal have been emptied or when a predefined minimum filling level is fallen short of, and for releasing all the resources used when no reconfiguration message has been received by the radio network controller after the status messages have been sent.

The wireless network according to the invention is understood to be a network comprising a plurality of radio cells in which a respective base station and a plurality of terminals transmit control data and useful data. A wireless transmission is used for transmitting information, for example, by radio, ultrashell or infrared paths.

According to the invention, the resources used in the terminal are released (for example disconnection of the terminal) after a certain number of status messages have been sent, and a waiting mode is changed to in which a terminal can again be reached by the radio network controller. On the other hand, the radio network controller detects an inactivity when data or messages are no longer received from a terminal after a certain period of time and the controller sends a reconfiguration message coded with the right key to the terminal. Since the terminal uses the false key, it cannot recognize as such the reconfiguration message coded with the right key. As a result, after a certain number of status messages have been sent, the waiting mode is autonomously changed to in the terminal.

The invention also relates to a terminal in such a wireless network.

Examples of embodiment of the invention will be further explained with reference to the Figure, in which:

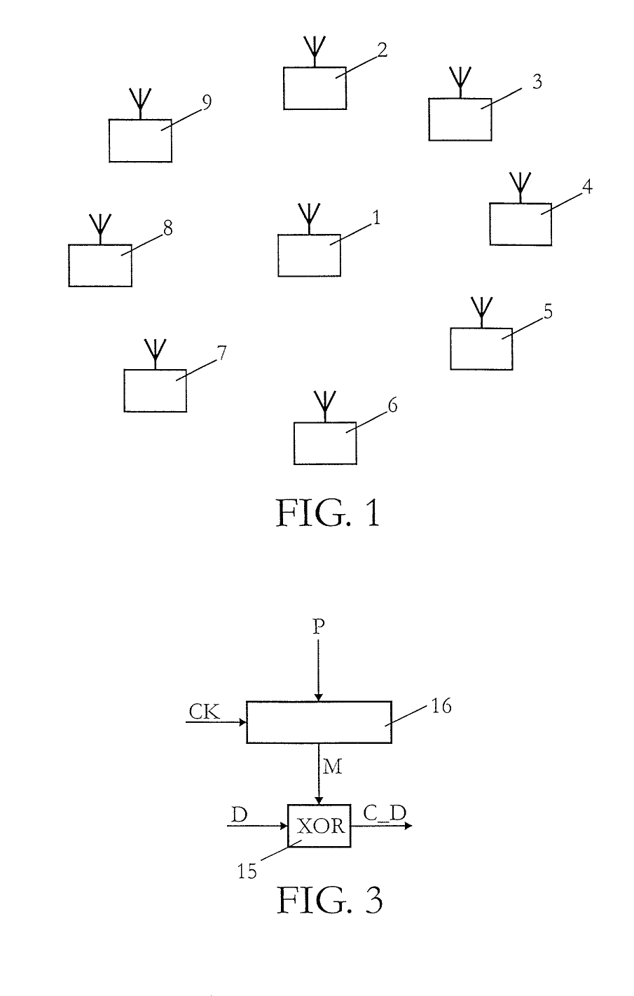

FIG. 1 shows a wireless network comprising a radio network controller and a plurality of terminals,

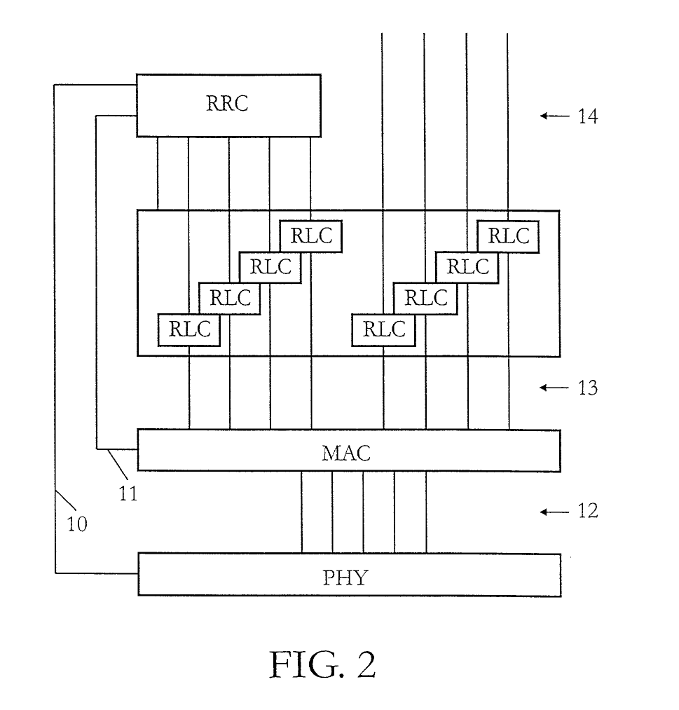

FIG. 2 shows a layer model to explain various functions of a terminal or of a radio network controller, and

FIG. 3 shows a block diagram to explain the coding mechanism in a terminal or in a radio network controller.

FIG. 1 shows a wireless network, for example a radio network, comprising a radio network controller (RNC) 1 and a plurality of terminals 2 to 9. The radio network controller 1 is responsible for controlling all the components playing a part in the radio traffic such as, for example, the terminals 2 to 9. An exchange of control and useful data takes place at least between the radio network controller 1 and the terminals 2 to 9. The radio network controller 1 sets up respective connections for the transmission of useful data.

As a rule, the terminals 2 to 9 are mobile stations and the radio network controller 1 is fixedly installed. A radio network controller 1 may, however, also be moving or mobile respectively.

In the wireless network radio signals are transmitted, for example, in accordance with the FDMA, TDMA or CDMA method (FDMA - Frequency-Division Multiple Access, TDMA=Time-Division Multiple Access, CDMA=Code-Division Multiple Access), or in accordance with a combination of the methods.

With the CDMA method, which is a special code spreading method, binary information (data signal) coming from the user is modulated with a respective code sequence. Such a code sequence comprises a pseudo-random square-wave signal (pseudo-noise code) whose rate, also called chip rate, is usually considerably higher than that of the binary information. The duration of the square-wave pulse of the pseudo-random square-wave signal is referred to as a chip interval T_{C}. 1/T_{C} is the chip rate. The multiplication or modulation respectively, of the data signal by the pseudo-random square-wave signal results in the spreading of the spectrum by the spreading factor N_{C}=T/T_{C}, where T is the duration of a square-wave pulse of the data signal.

Useful data and control data between at least one terminal (2 to 9) and the radio network controller 1 are transmitted by channels predefined by the radio network controller 1 . A channel is determined by a frequency range, a time range and, for example, in the CDMA method, by a spreading code. The radio link from the radio network controller 1 to the terminals 2 to 9 is referred to as a down-link and from the terminals to the base station as an up-link. Thus, down-link channels transport data from the base station to the terminals and up-link channels from the terminals to the base station.

For example, a down-link control channel may be provided, which is used for broadcasting control data from the network controller 1 to all the terminals 2 to 9 prior to a connection set-up. Such a channel is referred to as a down-link broadcast control channel. For transmitting control data from a terminal 2 to 9 to the radio network controller 1 prior to a connection set-up, it is possible to use, for example, an up-link control channel assigned by the radio network controller 1 , which, however, may also be accessed by other terminals 2 to 9. An up-link channel that can be used by various terminals or all of them (2 to 9) is referred to as common up-link channel. After a connection has been set up, for example between a terminal 2 to 9 and the radio network controller 1, useful data are transmitted by a down-link and an up-link user channel. Channels which are only set up between one transmitter and one receiver are referred to as dedicated channels. As a rule, a user channel is a dedicated channel that can be attended by a dedicated control channel for the transmission of link-specific control data. To include a terminal 2 to 9 in a radio network controller 1, a free-access contention channel is appropriate.

For useful data to be exchanged between the radio network controller 1 and a terminal it is necessary that a terminal 2 to 9 is synchronized with the radio network controller 1. For example, from the GSM system (GSM=Global System for Mobile communications), in which a combination of FDMA and TDMA methods is used, it is known that after a suitable frequency range has been determined on the basis of specified parameters, the position in time of a frame is determined (frame synchronization), with the aid of which frame the order in time for transmitting data is determined. Such a frame is always necessary for the data synchronization of terminals and base station in TDMA, FDMA and CDMA methods.

The exchange of control data and useful data via the radio interface between the radio network controller 1 and the terminals 2 to 9 may be explained with the aid of the exemplary layer model shown in FIG. 2, or protocol architecture (compare for example ₃rd Generation Partnership Project; Technical Specification Group Radio Access Networks; Interlayer Procedures in Connected Mode (3G TS 25.303 version 3.2.0). The layer model consists of three protocol layers: the physical layer PHY, the data link layer with the sublayers MAC and RLC (FIG. 2 shows various shapes of the sub-layer RLC) and the layer RRC. The sub-layer MAC is used for the Medium Access Control, the sub-layer RLC for the Radio Link Control and the layer RRC for the Radio Resource Control. The layer RRC is responsible for the signaling between the terminals 2 to 9 and the radio network controller 1. The sub-layer RLC is used for controlling a radio link between a terminal 2 to 9 and the radio network controller 1. The layer RRC controls the layers MAC and PHY via the control links 10 and 11. Thus the layer RRC can control the configuration of the layers MAC and PHY. The physical layer PHY offers transport links 12 to the MAC layer. The MAC layer renders logic links 13 available to the RLC layer. The RLC layer can be reached by applications via access points 14.

In such a wireless network the data are transmitted via the radio interface in coded form for reasons of security and reliability to avoid the data being “listened in”. The coding is effected in the data link layer (for example, in the RLC or MAC layer). As shown in FIG. 3 the data D are combined with a coding mask M via an Exclusive-OR function (XOR), so that a coded data stream C_D is the result. The coding mask M is formed in a coding function 16, which works in accordance with a coding algorithm and receives as input values the key CK and other parameters P not further shown here.

The key is to be known both to the radio network controller 1 and to the terminals 2 to 9. This key is changed at particular instants (for example every second hour) with a special procedure CKC (cipher key change). With this procedure local messages are transmitted between the layers RLC and RRC.

At regular intervals the key with which a terminal 2 to 9 and the radio network controller 1 respectively generate the coding mask is changed. For this purpose, a network (core network) provided for the management functions sends a random number (random challenge) to the radio network controller and a terminal from which random number both a terminal and the radio network controller calculate the new key to be used by means of a secret key algorithm. The radio network controller and a terminal furthermore calculate a further comparison number while using the random number, which random number is sent over the radio interface to the radio network controller by the terminal. If the respectively calculated comparison numbers match, the terminal is considered to be authenticated.

If an error occurs while the key is being calculated in the terminal, or if the key is erroneously transmitted, the terminal will utilize false coding masks and will no longer be understood by the radio network controller after it has received a coded message. After the false new key has been used, applications running in the terminal establish that they can no longer receive or transmit sensible new data from or to the radio network controller. Since this state of a continuously erroneous transmission inevitably continues to exist, the applications stop operating.

This means that in the terminal all the queues containing messages or data are emptied. Queues are necessary for buffering messages or data respectively in the terminal. As a consequence of the emptied queues, the terminal sends coded status messages (measurement reports) to the radio network controller via a dedicated control channel (DCCH) to inform the controller of the filling level of the queues. Since in this case the false key is used, the radio network controller cannot understand these status messages and rejects them. Simultaneously, the radio network controller detects an inactivity on the dedicated control channel (DCCH) which is assigned to the terminal, because on this user channel no transport blocks arrive any more, because the applications have been turned off. After establishing the inactivity after a specific period of time, the radio network controller sends a coded configuration message (radio bearer reconfigure) to the terminal. Normally, when the key is not received wrong by the terminal, the reception of this reconfiguration message is acknowledged by the terminal by an acknowledge message. After detecting the inactivity and after a waiting time for the reception of the acknowledgement message, the radio network controller considers the channel or channels used thus far to be free. However, in the terminal there is an error situation because it cannot release the resources used since the reconfiguration message has not been received.

Since the terminal and the radio network controller can no longer communicate with each other via (coded) control messages, according to the invention the elimination of the error situation is effected implicitly.

In the terminal the queues are empty—as explained above—after the data of the applications have been exchanged with the radio network controller. Because of the empty queues, the terminal sends coded status messages to the radio network controller over a dedicated control channel (DCCH). These status messages show that the queues are empty or have constantly fallen short of a predefined minimum filling level. After N status messages have been sent, the terminal expects a coded reconfiguration message from the radio network controller. This message is received, it is true, but cannot be understood after a decoding with the false key.

According to the invention, after sending N status messages and not having received an intermediate coded reconfiguration message from the radio network controller, the terminal will release the resources used and change to a waiting mode in which a link can be set up again. This measure ensures that in the rare case of a false key in the terminal, the terminal changes to a waiting mode after all applications have been broken off, in which waiting mode the terminal can again be reached by the radio network controller over an uncoded control channel.

1. A wireless network comprising a radio network controller and a plurality of assigned terminals which are provided for coding specific data to be transmitted in dependence on a key that can be changed at certain intervals, characterized in that a terminal is provided for sending a predefined number of status messages in the case of an erroneously used key after all the queues in the terminal have been emptied or when a predefined minimum filling level is fallen short of, and for releasing all the resources used when no reconfiguration message has been received by the radio network controller after the status messages have been sent.

2. A wireless network as claimed in claim 1, characterized in that, when no further data or messages respectively are received from a terminal after a certain period of time, a radio network controller a provided for detecting an inactivity and sending a reconfiguration message to the terminal, which reconfiguration message is coded with the right key.

3. A wireless network as claimed in claim 2, characterized in that, owing to the false key, a terminal does not recognize a reconfiguration message coded with the right key.

4. A terminal in a wireless network comprising a radio network controller and further terminals for coding certain data to be transmitted in dependence on a key that can be changed at certain intervals, characterized in that the terminal is provided for sending a predefined number of status messages in case a false key is used, after all the queues in the terminal have been emptied or when a predefined minimum filling level is fallen short of, and for releasing all the resources used when no reconfiguration message has been received from the radio network controller after the status messages have been sent.
